(19) United States
(12) Patent Application Publication
(10) Pub. No.: US 2008/0093121 A1
(43) Pub. Date: Apr. 24, 2008

(54) Installation Bracket for Electrical Box, Electrical Box Assembly, and Method of Use

(75) Inventor: Ronald D. Webb, Pasadena, CA (US)

Correspondence Address: BANNER & WITCOFF, LTD., TEN SOUTH WACKER DRIVE, SUITE 3000, CHICAGO, IL, 60606, US

(73) Assignee: Alcan International Limited, Montreal (CA)

(21) Appl. No.: 11/873,209

(22) Filed: Oct. 16, 2007

Related U.S. Application Data
(60) Provisional application No. 60/829,991, filed on Oct. 18, 2006.

(51) Int. Cl. H02G 3/12

(52) U.S. Cl. 174/502

(57) ABSTRACT

Installation brackets facilitate securing of electrical boxes during building construction, for example within an internal cavity of a partition. Disclosed herein are installation brackets to which can be mounted electrical boxes of various sizes or depths, as well as electrical box assemblies including such installation brackets.

### CROSS-REFERENCE TO RELATED APPLICATION

This application claims the priority right of applicant's prior co-pending provisional application Ser. No. 60/829,991 filed Oct. 18, 2006.

### FIELD OF THE INVENTION

The invention relates to the field of electrical boxes, and brackets to position and retain such electrical boxes in a partition or on a wall.

### BACKGROUND TO THE INVENTION

During building construction or maintenance electrical outlets or switches, as well as other electrical devices, are positioned in or adjacent a partition or wall so that they are reachable by occupants of the building. These electrical devices are typically positioned in, or wired into, electrical boxes which are themselves be mounted in a cavity between two walls of a partition. The mounting process has often presented challenges to the building industry, and can be the cause of delay during construction.

Electrical box mounting is generally facilitated by the use of an installation bracket to position the electrical box at a desired position adjacent or near a rear face of a front wall of a partition. Several electrical box installation brackets are known in the art, and most share a number of common features. These include a mounting plate to which an electrical box can be mounted, the mounting plate generally defining an aperture there through or other opening to allow access to an internal cavity of any electrical box mounted to the bracket, and any electrical device retained therein. Importantly, the installation bracket may further include means to rigidly fix the bracket to a wall stud or a floor member, thereby to provide a secure mounting place for the electrical box immediately behind the front wall of the partition. In this way, the mounting plate may be located flush with or at least near to a rear surface of the front wall, with the electrical box extending back into the cavity. Access may be gained to the electrical box by a hole in the wall in line with the aperture of the mounting plate.

The complete electrical box assembly may further include a box ring or mud ring of a type that is well known in the art. Typically, a box ring or mud ring may be mounted to the installation bracket on a side opposite to the electrical box so as to pass though a hole in the wall which is cut (for example by a router) to accommodate the ring. The box ring may include an aperture that is continuous with an aperture in the mounting plate of the installation bracket once the box ring is secured thereto, so as to provide access an internal recess within an electrical box from the front exterior of the partition.

The size and depth of the required electrical box, the depth of the recess extending from the installation bracket into the electrical box, and the depth of the cavity of the partition, may vary according to the building project and the electrical devices to be installed in the partition. Selected electrical devices, such as for example speaker or horn devices, may be wider and/or deeper than other electrical devices such as electrical switches or sockets. Such larger electrical devices may require a significant mounting depth within a partition cavity, or may further require the use of a larger electrical box to accommodate their bulk. For this reason, an electrician installing such electrical box assemblies may be required to have numerous types and sizes of electrical boxes to hand, as well as numerous types and sizes of installation brackets corresponding to such electrical boxes. Importantly, the electrician must use skill and careful judgment to select an electrical box and associated components suitable to accommodate a particular electrical device before securing the electrical box and associated components in position in the partition cavity.

At times, it may not even be possible for the electrician to procure an electrical box having a size or depth sufficient to accommodate certain electrical devices. Under these circumstances, an electrician may be obliged to resort to the fashioning or combining of various components to achieve an electrical box assembly suitable to contain the required device in the partition cavity. For example, extension rings, plates or spacers may be located between the electrical box and the mounting plate of the installation bracket thereby to increase the overall depth of the recess extending from the mounting plate back into the electrical box, sufficient to accommodate the electrical device.

The selection of electrical boxes and corresponding electrical box components, as well as the possible manipulation of such components to make them ‘fit’ to required size or depth requirements of an electrical device, can be a rather haphazard and time-consuming procedure. Even an experienced electrician may require both skill and luck to select an electrical box and corresponding components to construct an electrical box assembly suitable for each application, and to successfully install such components in a partition cavity. It follows that there remains a continuing need to develop electrical box assemblies, and associated components thereof, that facilitate their installation and use. In particular, there remains a need for electrical box assemblies, and components thereof, that reduce the time or effort required by an electrician to select and install such components during building construction and maintenance.

### SUMMARY OF THE INVENTION

It is an object of the present invention, at least in preferred embodiments, to provide an electrical box assembly, or a component thereof, that is able to accommodate electrical boxes of more than one depth, for example in a cavity of a partition.

It is another object of the present invention, at least in preferred embodiments, to provide an electrical box assembly, or a component thereof, that is able to accommodate electrical boxes of more than one size, for example in a cavity of a partition.

It is another object of the invention, at least in preferred embodiments, to provide an installation bracket upon which can be mounted electrical boxes having a range of sizes and/or depths.

It is another object of the present invention, at least in preferred embodiments, to provide an improved method of installing or retaining an electrical box in or on a partition.

In one aspect of the present invention there is provided an installation bracket for mounting an electrical box to a partition comprising a front wall and a rear wall defining therebetween an interior space, the installation bracket comprising:
a mounting plate having an opening of sufficient size to receive therethrough an electrical device;
at least one stud or floor attachment means each for securing the installation bracket to a stud or a floor, thereby to position the mounting plate alongside a rear face of the front wall in the interior space; and
at least one mounting flange on at least one side of the opening in the mounting plate, each mounting flange extending from the mounting plate toward the rear wall, for mounting thereupon an electrical box, each mounting flange defining at least two electrical box anchor positions located at different distances toward the rear wall from a plane of the mounting plate, the installation bracket thereby accommodating electrical boxes of varying depths within the interior space of the partition.

In another aspect of the present invention there is provided an electrical box assembly comprising:
(1) the installation bracket as described above;
(2) an electrical box for mounting to the mounting flange(s) of the installation bracket; and
(3) a plurality of fasteners to fasten components (1), and (2) together.

In another aspect of the present invention there is provided a method of securing an electrical box within an interior space of a partition including a front wall and a rear wall to define the interior space, the method comprising the steps of:
mounting the installation bracket as described above to a stud or floor; and
mounting the electrical box to the mounting flange(s) of the installation bracket.

In another aspect of the present invention there is provided a kit for mounting an electrical box to a partition comprising a front wall and a rear wall defining therebetween an interior space, the kit comprising a first and second mounting bracket, each comprising:
a plate portion;
a stud or floor attachment means for securing the mounting bracket to a stud or a floor, thereby to position the plate portion of the mounting bracket alongside a rear face of the front wall in the interior space;
a mounting flange extending from the plate portion toward the rear wall, for mounting thereupon an electrical box, the mounting flange defining at least one electrical box anchor position;
whereby by in use the first and second mounting brackets are secured to a floor or stud so as to bring the mounting flanges into opposition, for securing therebetween an electrical box.

In another aspect of the present invention there is provided a method of securing an electrical box within an interior space of a partition including a front wall and a rear wall to define the interior space, the method comprising the steps of:
providing the kit of the present invention;
mounting each of the first and second mounting brackets to a stud or floor to bring the mounting flange portions of each mounting bracket into opposition; and
mounting the electrical box between the opposed mounting flange portions of the mounting brackets.

The present invention further encompasses any embodiment described herein, or any embodiment related to such embodiments.

### BRIEF DESCRIPTION OF THE DRAWINGS

FIG. 1a illustrates a preferred installation bracket and electrical box of the present invention (exploded view).

FIG. 1b illustrates a preferred electrical box assembly of the present invention comprising an installation bracket and electrical box in accordance with FIG. 1a.

FIG. 2a illustrates a preferred installation bracket and electrical box of the present invention (exploded view).

FIG. 2b illustrates a preferred electrical box assembly of the present invention comprising an installation bracket and electrical box in accordance with FIG. 2a.

FIG. 3a illustrates a preferred installation bracket and electrical box of the present invention (exploded view).

FIG. 3b illustrates a preferred electrical box assembly of the present invention comprising an installation bracket and electrical box in accordance with FIG. 3a.

FIG. 4 illustrates a cross-sectional view of an electrical box assembly of the present invention positioned adjacent and through dry wall.

FIG. 5 illustrates a preferred method of the invention for securing an electrical box on a wall or within an interior space of a partition.

FIG. 6 illustrates a preferred method of the invention for securing an electrical box on a wall or within an interior space of a partition.

FIG. 7 illustrates a preferred method of the invention for securing an electrical box on a wall or within an interior space of a partition.

FIG. 8 illustrates a preferred method of the invention for securing an electrical box on a wall or within an interior space of a partition.

### DEFINITIONS

Electrical box: refers to any box for retaining an electrical device therein, to be mounted on a rear side of a wall or in a cavity of a partition, such that the electrical device may be accessed and/or utilized from a front side of the wall, or external front side of the partition, or alternatively on another side of the electrical box as required. Preferably, an electrical box is made of a metal or metal alloy. Most preferably, the electrical box is cuboidal, and includes a substantially open side intended to face the aperture or opening in the installation bracket, with smaller orifices or openings on other sides for optional passage therethrough of electrical wires for connecting the electrical device(s) retained in the electrical box. In a preferred embodiment of the present invention, the electrical box has sufficient depth to accommodate the electrical device and to pass through the aperture in the installation bracket and extend through the hole in the adjacent wall. In certain embodiments this forward portion of the electrical box may be a separate annular ring, mechanically fixed to the box prior during assembly. The separate annular ring may have a different shape, for example, it may be the shape form of a box ring such as described in U.S. patent application 60/829,602 filed on Oct. 16, 2006. In most preferred embodiments the electrical box combination may be sized so that it can easy slide back and forth through the aperture in the installation bracket until a desired depth of the electrical box is achieved in the wall or partition. The electrical box typically, but not necessarily, includes an open side adjacent or near the installation bracket to which it is affixed so that access may be gained to an interior space of the electrical box via an opening in the installation bracket. Alternatively, or additionally, the electrical box may include an optionally removable back plate forming a side of an electrical box generally opposite the side adjacent an installation bracket, so that access to the interior space may be achieved from a rear side of the electrical box relative to a front wall and installation bracket of the invention. In such embodiments, the electrical box may include both a back plate portion as well as an annular extender to provide depth to the electrical box. The depth of the annular extender may be selected according to the desired application, the electrical device to be retained in the electrical box, and/or the depth of a cavity in a partition.

Electrical box assembly: refers to any assembly at least comprising an installation bracket of the present invention in combination with an electrical. Further optional components of the assembly may include one or more electrical devices, fasteners etc.

Electrical device: typically refers to any electrical device to be at least partially retained within an electrical box in accordance with the teachings of the present invention. Moreover, such a device may be reachable from the electrical box by occupants of a building in which the electrical device is located. For example, such as electrical device may be selected from the following non-limiting group: a switch, a socket, an electrical motor, a speaker, a horn etc. In any embodiment of the present invention, the electrical box or electrical box assembly may be suitable for the incorporation of multiple gangs of electrical devices.

Fastener: refers to any means of fixing or binding one component to another such as for example components of an electrical box assembly in accordance with the teachings herein. A fastener typically includes a nail, or a threaded fastener such as a bolt and nut, or a threaded screw such as a self-tapping screw. Other fasteners may include a curable or settable material suitable to adhere one surface to another, such as a glue.

Installation bracket: refers to any device that is able to mount thereupon and retain in a desired position an electrical box on a wall or within a cavity of a partition. The installation bracket, in a basic form, may include some means upon which the electrical box may be mounted to the bracket, as well as some means to mount the bracket to a secure or fixed object forming part of or adjacent the wall or partition, such as a wall stud or floor member. In accordance with the teachings of the present invention, a preferred installation bracket may further include one or more mounting flanges to assist in mounting of an electrical box thereto.

Mounting bracket: refers to a component of a kit of the present invention, wherein two mounting brackets function together to secure an electrical box in a desired position.

Mounting flange: refers to any flange or portion of material attached to, integral with, or extending from selected installation brackets of the present invention, or at least extending adjacent mounting plates thereof. Preferably, each mounting flange assists in holding, retaining or securing en electrical box to an installation bracket in accordance with the teachings of the present invention. A mounting flange may preferably include one or more anchor positions for affixing, mounting or securing thereto an electrical box or a component thereof. For example, a mounting flange may contact and support an electrical box, and further may include means to permit fasteners to help fasten the electrical box to each mounting flange, thereby to help secure or mount the electrical box to the installation bracket. In most preferred embodiments, a mounting flange may be integral to a mounting plate of an installation bracket, wherein the bracket is formed by stamping or cutting sheet metal, and bending a portion of the stamped or cut section of sheet metal at an angle, preferably about a 90° angle, relative to a plane of the mounting plate.

Further, the bending of the aforementioned portion may result in the generation of an aperture or opening in the installation bracket suitable to allow access to an internal recess of an electrical box mounted thereto, and in a preferred embodiment of the present invention to allow passage therethough of an electrical box prior to final assembly of the electrical box assembly.

Mounting plate: refers to a portion of an installation bracket of the present invention, which may be positioned alongside or near an internal surface front wall of a partition, so that an electrical box may be affixed thereto or therethrough, for example via adjacent mounting flanges. Typically, a mounting plate may form a main structural feature of an installation bracket of the present invention, such that floor stud or wall member attachment brackets, as well as mounting flanges, may extend therefrom. Typically, but not necessarily, a mounting plate may include a substantially planar or plate like member, that takes any shape or form, and includes an aperture located therein to allow access to an internal recess of an electrical box mounted thereto, and in a preferred embodiment of the present invention to allow passage therethrough of an electrical prior to final assembly of the electrical box assembly. In many embodiments, the mounting plate may be a single section of material for example stamped or molded from a metal sheet. However, in still further embodiments the mounting plate may have more than one part, such as two distinct mounting plates either separate but coordinating to define therebetween a space equivalent to an aperture of a regular mounting plate, or alternatively, the two mounting plates may be slidably connected to permit a distance between the plates, or at least mounting flanges on the plates or portions thereof, and a size of an aperture defined between the plates, to vary. In this way, electrical boxes of various widths may be accommodated by preferred installation brackets of the invention.

Partition: refers to any wall upon which or adjacent which an electrical box is to be mounted. In preferred embodiments the partition includes two walls (e.g. a front wall and a rear wall) defining therebetween a cavity, wherein an electrical box may be mounted within the cavity in accordance with the teachings of the present invention. Most preferably, the electrical box may be mounted on or adjacent a rear surface (i.e. a surface internal to the cavity) of the front wall of the partition. The partition, including the front wall and the rear wall where present, may comprise any material suitable for forming the partition. More commonly, the partition may comprise drywall, wood, expanded polystyrene, insulative foam, or any other materials commonly used in the building industry.

Preferred/preferably: unless otherwise stated refers to features that limit only the broadest embodiments of the invention.

### DETAILED DESCRIPTION OF THE INVENTION

Installation brackets according to the present invention can accommodate electrical boxes of various sizes. Mounting of an electrical box to an installation bracket of the invention simply involves adjusting the installation bracket (or components thereof) in a manner to suite the size (e.g. width) or depth of the electrical box, and then securing the electrical box to the installation bracket for example by way of suitable fasteners. The adaptability of the installation brackets facilitates electrical box placement during building construction, making such placement more secure as well as saving valuable time of skilled electricians.

Depending upon the application, the installation brackets of the present invention in various embodiments may allow for mounting of electrical boxes of variable width, variable height, variable depth, or variable width and/or height and/or depth. In this way, an electrician working at a building construction side can readily and without difficulty adapt the installation brackets of the invention to suit the electrical devices to be installed, and the electrical boxes required to accommodate the electrical devices.

Preferred embodiments of the installation brackets and corresponding electrical box assemblies will now be described with specific reference to the drawings. The embodiments are illustrated for exemplary purposes only, and in no way limit the scope of the invention disclosed herein.

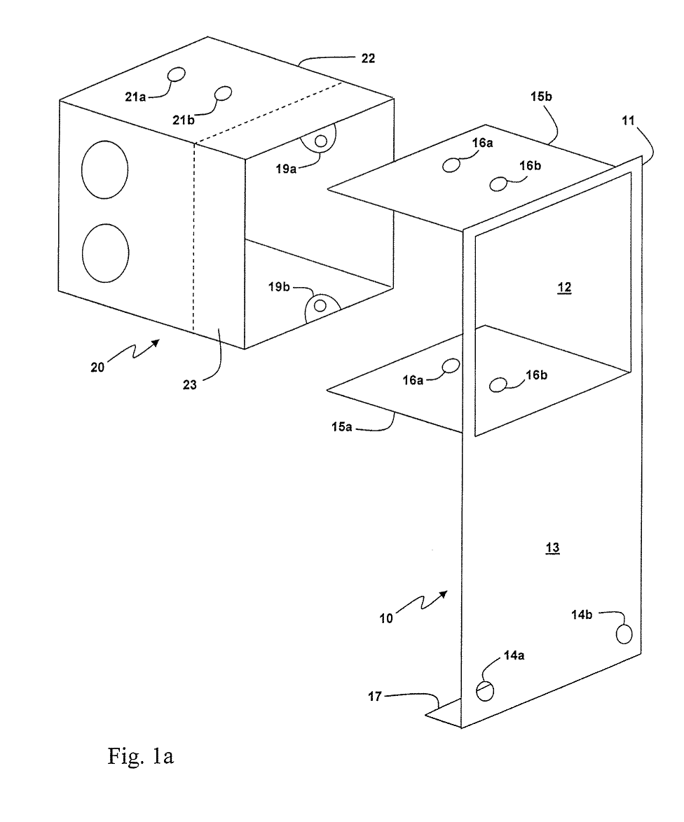

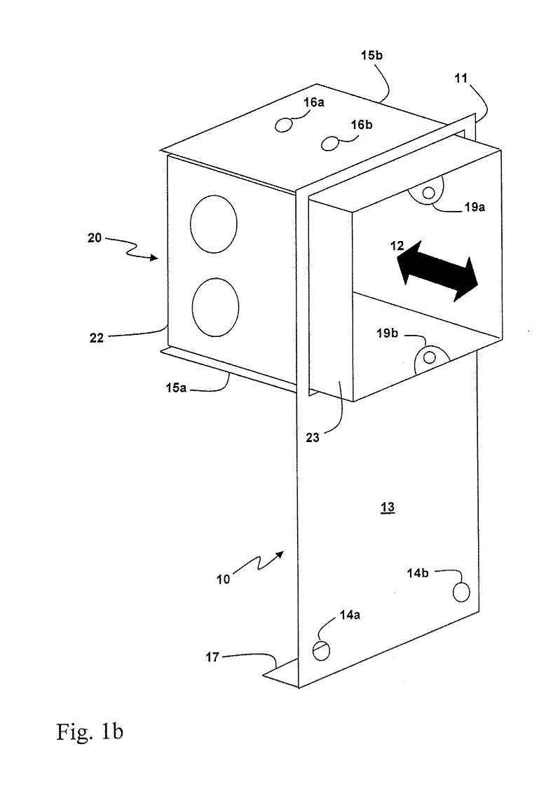

Turning first to FIG. 1a, there is shown a preferred installation bracket of the present invention shown generally at 10. The bracket includes a mounting plate 11 defining an aperture or opening 12 to allow for access to an internal space of an electrical box 20 to be mounted to the bracket. The opening 12 may be smaller than the dimensions of an electrical box such that the box is affixed to the mounting plate, but unable to pass through the opening 12. However, in more preferred embodiments the opening 12 has a size sufficient for passage therethrough of electrical box 20. For example, opening 12 may have a size just sufficient for the electrical box 20 to be mounted in a sliding relationship through the installation bracket. In this way, the electrical box may be positioned for example though an installation bracket from a front side of a wall, or loosely secured to the installation bracket, adjusted until a desired depth is achieved relative to the mounting plate and the front wall, and then secured in position for example by tightening suitable fasteners in a manner that will become further apparent from the foregoing.

The bracket 10 further includes stud or floor attachment means 13 comprising orifices 14a, 14b for passage therethrough of fasteners (not shown) to secure the bracket to a stud or floor member for example using self-tapping wood-screws. Although not shown, orifices 14a and 14b could alternatively be located on additional flange 17. Once the bracket 10 is secured to a stud or floor member, mounting plate 11 is typically positioned alongside or near to a rear face of a wall of a partition, for example within a cavity between two walls of the partition.

An important feature of the bracket 10 includes mounting flanges 15a, 15b that are affixed to or generally integral with mounting plate 11. Although two mounting flanges are illustrated in FIG. 1, disposed on each side of opening 12, one or more mounting flanges may be present as required. Each mounting flange includes orifices 16a, 16b therethough intended for alignment with one or more of orifices 21a, 21b of side wall 22 of electrical box 20. Electrical box 20 can be positioned between (or slid over if dimensions allow) mounting flanges 15a, 15b until either or both of orifices 21a and 21b of the electrical box align with either or both of orifices 16a and 16b of the mounting flanges. In this way, an electrician may select a required depth for electrical box 20 relative to mounting plate 11 according to whether orifices 16a and 16b both align with orifices 21a and 21b, or alternatively whether (if more depth is required) only orifice 16a aligns with orifice 21b. In any event, once the required orifices are aligned to achieve the required depth of the electrical box, fasteners may be passed through the orifices to secure the electrical box to the mounting flanges.

FIG. 1a further illustrates two preferred features of the electrical box 20. Firstly, the electrical box has a forward portion 23 (differentiated from the main portion of the electrical box by a dotted line) such that when the electrical box may be positioned as shown for example in FIG. 1b, with the electrical box 20 extending though opening 12 in installation bracket 10, with the forward portion of the electrical box extends beyond or in front of a front face of the mounting plate 11. The double arrow shown in FIG. 1b illustrates how the electrical box 20 may be slid backwards and forwards through opening 12 as required to achieve a desired depth in a wall (not shown) so that the forward portion is also positioned as required. The forward portion 23 of the electrical box may in certain embodiments (not shown) be made as separate piece, mechanically fixed to the box during assembly so it slides back and forth with the box. This allows flexibility in altering the geometry and even the size of opening of the forward portion of the box. A typical separate piece may take the form of a box ring design as would be known to those skilled in the art. Also shown in FIG. 1a and 1b are mounting tabs 16a and 16b on electrical box 20. These mounting tabs may have several uses, such as for example the addition or mounting of another component such as a cover plate to the box.

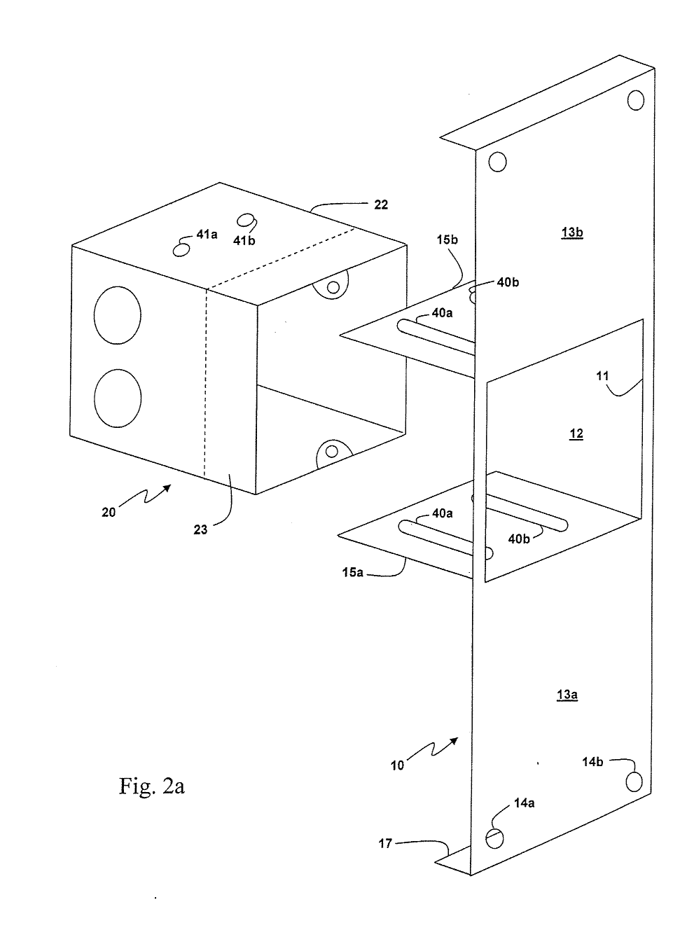

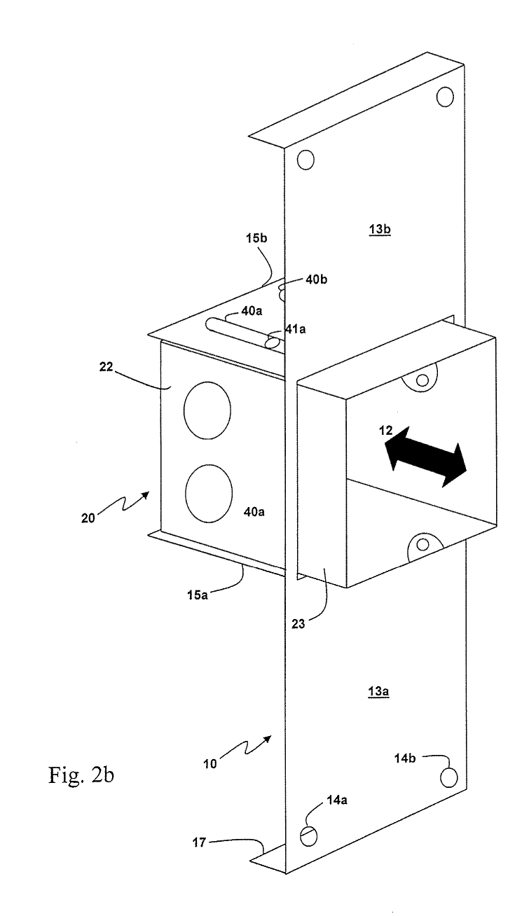

Another embodiment of the invention, similar to that shown in FIGS. 1a and 1b, is shown in FIG. 2a. In this embodiment, the mechanism of attachment of the electrical box 20 to the mounting flanges 15a, 15b is slightly different to that shown in FIG. 1, in that orifices 16a, 16b are replaced by at least one slot extending in each mounting flange generally away from a plane of the mounting plate, towards a rear wall of a partition (not shown). In FIG. 2, two substantially parallel slots 40a, 40b are illustrated in each mounting flange, which allow electrical box 20 to be affixed thereto via fasteners (not shown) extending through orifices 41a, 41b in side wall 22 of the electrical box. It will be appreciated that the slots 40a, 40b permit greater freedom of choice regarding the exact depth of the electrical box relative to the mounting plate. An electrician installing the electrical box may, for example, first loosely attach the electrical box via fasteners passing thought orifices 41a, 41b, and slots 40a, 40b, and slide the electrical box in and out, the fasteners sliding in slots 40a, 40b, until the desired depth for the electrical box is attained. Then, the electrical box may be more tightly secured in position on the installation bracket by tightening the aforementioned fasteners. A skilled artisan will further appreciate that slots corresponding to slots 40a, 40b may instead be disposed in side wall 22 of electrical box 20, with mounting flanges 15a, 15b including orifices for the fasteners.

Mounting flanges 15a, 15b may be affixed or integral with mounting plate 11 in any way or form. In most preferred embodiments, the mounting plate and the mounting flanges may comprise the same material, and may be stamped, cut from a single sheet of material, or molded from a material, such as a metal or metal alloy. In this scenario, mounting flanges 15a, 15b may each be formed by bending or folding a portion of the formed material as required, optionally assisted by scoring the material. The same applies for stud or floor attachment means 13.

Also illustrated in FIG. 2a are two floor or stud attachment means 13a and 13b extending on opposite sides of opening 12 in installation bracket 10. Flange 17 on each floor or stud attachment means may assist in positioning and/or securing of the bracket relative to a stud or floor member. This is in particular useful for floor mounting and may be omitted for stud mounting.

FIG. 2b illustrates how electrical box 20 may be positioned though opening 12 in installation bracket 10 prior to securing of the electrical box thereto. The double-ended arrow illustrates how the position of the electrical box may be adjusted prior to securing of the electrical box to the installation bracket via mounting flanges 15a and 15b. Note how orifice 41a aligns with slot 40a in the mounting flange 15b so that a fastener may be passed through both the mounting flange 15b as well as wall 22 of electrical box 20.

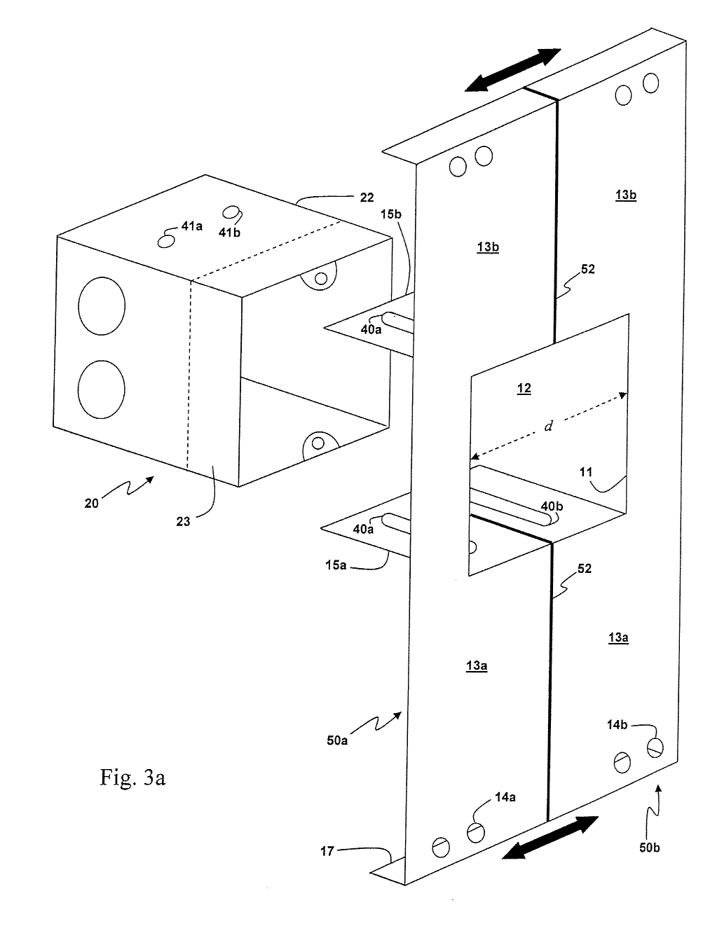

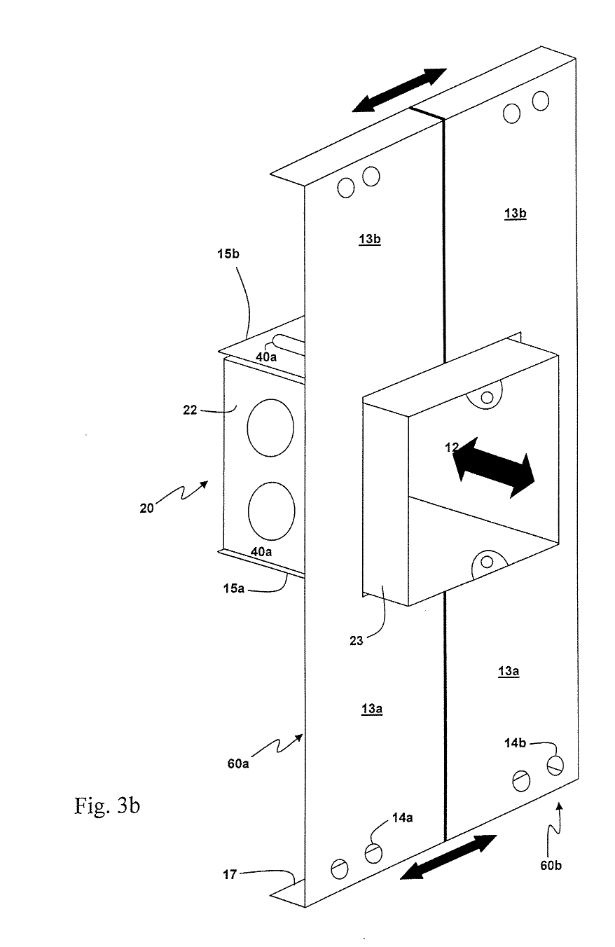

A further preferred embodiment of the installation bracket of the invention is illustrated in FIG. 3a. This embodiment is similar to those embodiments illustrated in FIGS. 1 and 2, with an important additional feature. In FIG. 3, mounting plate 11 is formed of two distinct mounting plate sections 50a, 50b that are moveable relative to one another (see double-ended arrows) thereby to vary the distance d across a width of opening 12. In this way, installation bracket 10 is able to accommodate not only electrical boxes of varying depth (as discussed in relation to FIGS. 1 and 2) but also electrical boxes of varying width or height. Preferably, mounting plate sections 50a, 50b are fixed to one another in a sliding relationship, so that the distance d can be altered without risk of otherwise disrupting the relative orientation or positions of the sections. As shown in FIG. 3a, mounting plate sections 50a and 50b may each be separately attached to a stud or to a floor for example via stud or floor attachment means 13a, 13b (although only one of 13a and 13b may be required if plate sections 50a and 50b are suitably attached to one another in sliding relationship). However, mounting plate sections 50a, 50b need not necessarily be connected in any way. The invention further encompasses embodiments virtually identical to that shown in FIG. 3a, with the exception that the mounting plate is formed from two distinct and separate mounting plate sections, which can also be moved relative to one another to vary distance d. The formation of the mounting plate from such two distinct mounting plate sections does not depart from the scope of the present invention, since the sections still co-operate to achieve a desired function of the installation bracket to secure an electrical box in a desired position. However, in preferred embodiments each mounting plate section may be required to be independently secured to a wall stud or floor member via stud or floor attachment means.

It should also be noted that the relative orientation of the mounting flanges shown in FIG. 3a may be altered. In FIG. 3a, interface 52 between mounting plate sections 50a and 50b bisects each of mounting flanges 15a and 15b. In still further embodiments, the mounting flanges may be located on left and right sides of opening 12 such that each of mounting plate sections 50a and 50b includes an entire mounting flange. Still further embodiments of the invention may comprise mounting flanges integral with the mounting brackets on all sides of opening 12. Alternatively, if opening 12 has a shape other than square or rectangular, multiple mounting flanges may be present as required, or in the case of a circular or oval opening 12 a tubular mounting flange may be used.

Corresponding FIG. 3b illustrates an electrical box assembly in which the electrical box 20 has been positioned through opening 12 located between mounting plate sections 50a and 50b. The additional double-ended arrow (compared with FIG. 3a) illustrates how the electrical box can be moved backwards and forwards to a desired position relative to the installation bracket 10 and wall (not shown).

The present invention further includes, at least in selected embodiments, a kit for mounting an electrical box to a partition comprising a front wall and a rear wall defining therebetween an interior space, the kit comprising a first and second mounting bracket, each mounting bracket comprising: (1) a plate portion; (2) a stud or floor attachment means for securing the mounting bracket to a stud or a floor, thereby to position the plate portion of the mounting bracket alongside a rear face of the front wall in the interior space; (3) a mounting flange extending from the plate portion toward the rear wall, for mounting thereupon an electrical box, the mounting flange defining at least one electrical box anchor position, or more preferably at least two electrical box anchor positions, located at different distances toward the rear wall from a plane of the front wall, the mounting bracket thereby accommodating electrical boxes of varying depths within the interior space of the partition; whereby in use the first and second mounting brackets are secured to a floor or stud so as to bring the mounting flanges into opposition, for securing therebetween an electrical box. Preferably, the kit may further comprise any one or more of the following additional components:
an electrical box;
a plurality of fasteners to fasten each mounting bracket to a stud or floor; and
a plurality of fasteners to fasten each mounting bracket to a box ring, or any electrical box, or to fasten the mounting brackets to one another.

The embodiments of the invention shown in FIG. 3 may include mounting flanges 15a, 15b to affix an electrical box to the installation bracket. However, the invention further encompasses embodiments of the invention in which mounting flanges 15a, 15b are absent, so that electrical box 20 is affixed to the mounting plate via more traditional means, for example employing direct securing via fasteners though orifices in the mounting plate. Such embodiments of the installation bracket are expected to accommodate electrical boxes of varying widths (by virtue of the moveability of the mounting plate sections 50a, 50b relative to one another), but exhibit less flexibility with regard to the accommodation of electrical boxes of varying depths (as shown in FIGS. 1 and 2).

It will also be appreciated that several embodiments of the invention illustrated in the Figures include mounting flanges extending upwards and downwards relative to the mounting plate of the installation bracket. The invention further encompasses installation brackets and corresponding electrical box assemblies, in which the brackets or assemblies are effectively rotated though 90° relative to the embodiments illustrated, thereby to dispose the mounting flanges of the installation brackets at left and right sides of the opening in the mounting plate.

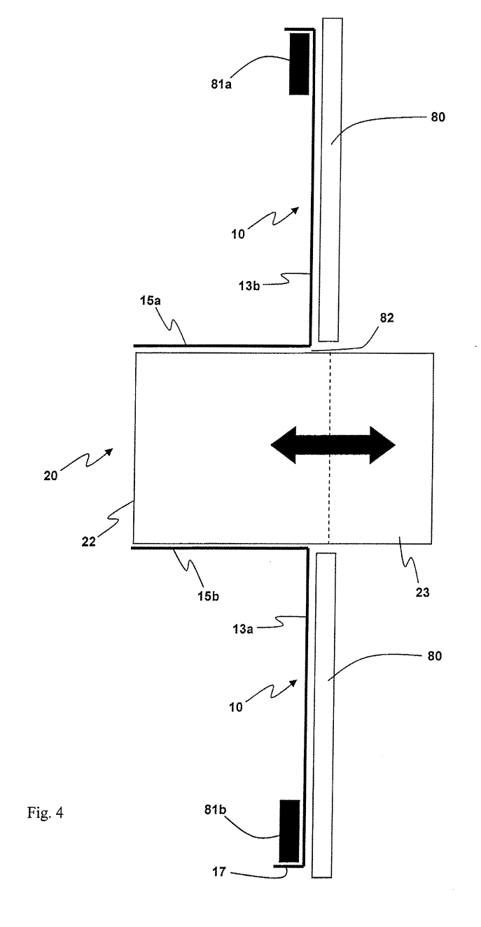

Further, in any of the illustrated embodiments of the invention, the orientation of the stud or floor attachment means 13a and 13b may be changed according to the application. For example for stud attachment the stud or floor attachment means may be better oriented at 90° compared to the embodiments illustrated so that stud attachment to two different studs may be effected without difficulty. This type of configuration is illustrated by reference to FIG. 4, which provides a cross-sectional view of an electrical box assembly of the invention mounted between two studs. A section of dry wall 80 is shown with a hole or opening 82 therein. The installation bracket is shown generally at 10, with a mounting plate and/or stud attachment means running generally flush with a rear side of the dry wall 80. End portions of the installation bracket are secured via fasteners (not shown) to studs 81a, 81b. Electrical box 20, comprising a forward portion 23 extending through opening 82 in the dry wall 80 is secured to mounting flanges 15a, 15b of the installation bracket 10 via fasteners (not shown). The double arrow illustrates how the electrical box 20 may be moved backwards and forwards relative to the installation bracket and dry wall until a desired depth of the electrical is achieved.

The present invention further encompasses an electrical box assembly comprising:
(1) any installation bracket of the present invention;
(2) an electrical box for mounting to the mounting flange(s) of the installation bracket; and
(3) a plurality of fasteners or an adhesive material to fasten components (1) and (2) together.

Such an electrical box assembly may take any form, and may comprise a kit of separate parts for assembly into an electrical box assembly, as well as an assembled electrical box assembly either independent to or integral with a wall or partition.

It should be noted that in the embodiments of the invention shown in FIGS. 1 to 4, or indeed any other embodiment of the installation bracket, electrical box assembly, or kit of the present invention, the opening 12 may be smaller than the dimensions of the electrical box 20 such that an electrical box may be affixed to the mounting plate, but unable to pass through the opening.

However, in the preferred embodiments (generally illustrated in the Figures) the opening 12 has a size sufficient for passage therethrough of electrical box 20. For example, opening 12 may have a size just sufficient for the electrical box 20 to be mounted in a sliding relationship with the installation bracket. In this way, the electrical box may be positioned or loosely secured through or adjacent the installation bracket, positioned at a desired depth relative to the mounting plate and the front wall, and then secured in position for example by tightening suitable fasteners. Such embodiments are particularly preferred, since the resulting electrical box assembly may include little or no gap between the electrical box and the installation bracket. Furthermore, the electrical box, and optionally an integral box ring if present, may be inserted through the opening in an installation bracket that has been pre-installed in a wall. The electrical box may be further provided with a detachable back plate, so that access to an interior volume of the electrical box may be gained from a rear side thereof, opposite the side adjacent the mounting plate. In this way, the electrical box may include a back plate portion and an annular extender to provide depth to the electrical box, wherein the annular extender may have any suitable depth according to the electrical device to be contained in the electrical box, and/or the depth of a cavity in the dry wall.

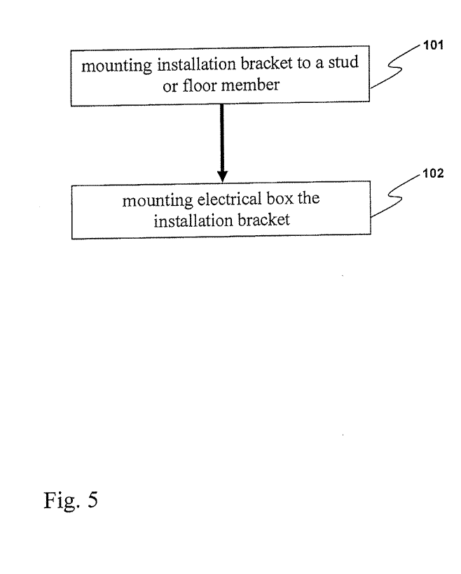

A preferred method of the invention is illustrated with reference to FIG. 5.

This method provides for the securing of an electrical box within an interior space of a partition including a front wall and a rear wall to define the interior space, the method comprising:
in step 101 mounting an installation bracket of the present invention comprising mounting flange(s) to a stud or floor; and
in step 102 mounting the electrical box to the mounting flange(s) of the installation bracket.

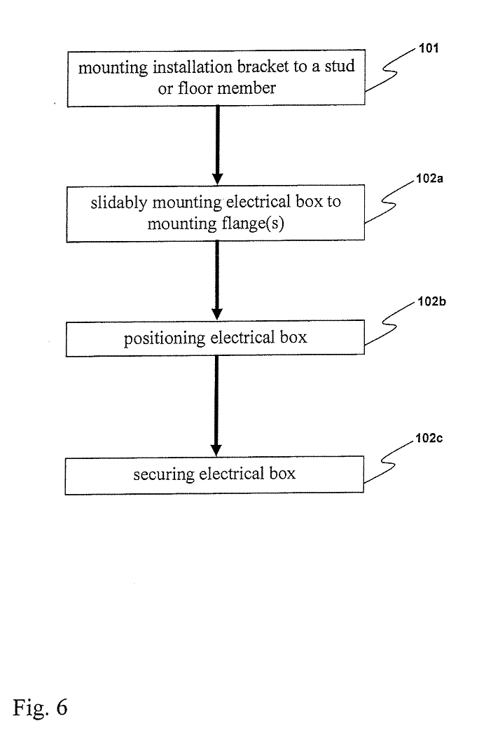

A preferred method of the invention, corresponding to the method of FIG. 5, is shown in FIG. 6. In this method, step 102 of mounting the electrical box to the mounting flanges of the installation bracket shown in FIG. 5, is broken into three distinct steps 102a, 102b, and 102c.
in step 102a, the electrical box is slidably mounted to the mounting flange(s) using threaded fasteners;
in step 102b the electrical box is positioned at a desired position relative to a plane of the mounting plate; and
in step 102c the electrical box is secured at the desired position by tightening the threaded fasteners.

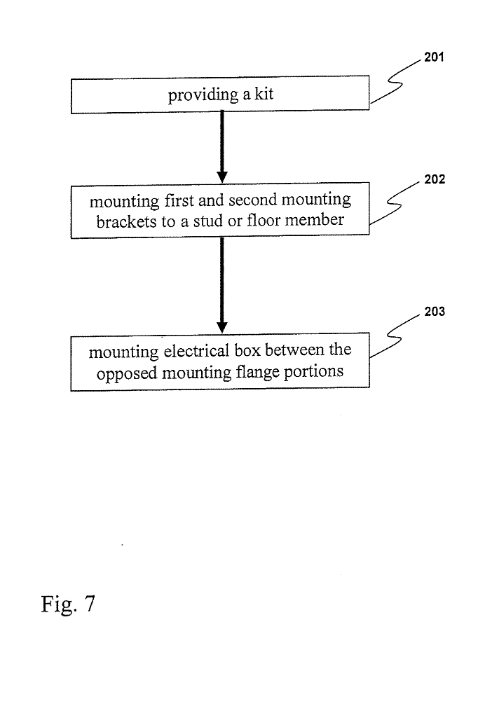

Another preferred method of the invention is shown in FIG. 7, for securing an electrical box within an interior space of a partition including a front wall and a rear wall to define the interior space, the method comprising the steps of:
in step 201 providing a kit of the present invention, as previously described;
in step 202 mounting each of the first and second mounting brackets to a stud or floor to bring the mounting flange portions of each mounting bracket into opposition; and
in step 203 mounting the electrical box between the opposed mounting flange portions of the mounting brackets.

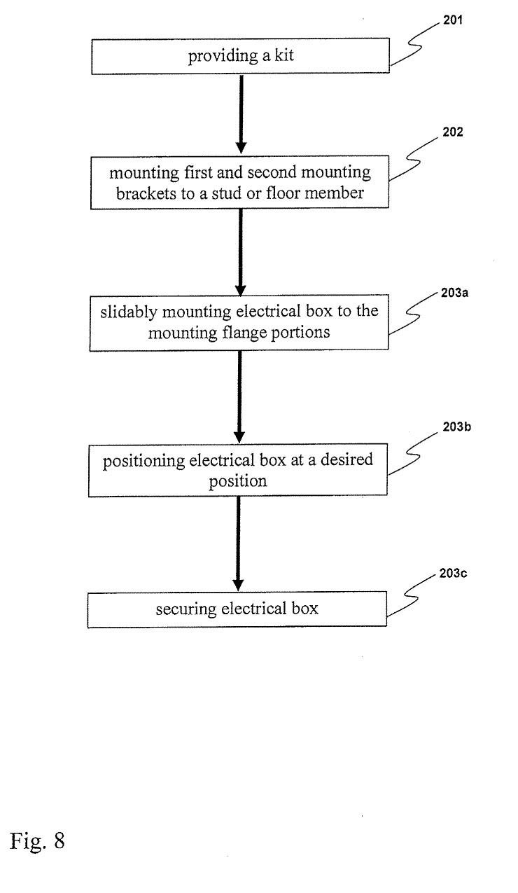

A preferred method of the invention, corresponding to that shown in FIG. 7, is illustrated with reference to FIG. 8. In this method, step 203 of mounting the electrical box discussed with reference to FIG. 7 is broken out into steps 203a, 203b, and 203c, wherein:
step 203a involves slidably mounting the electrical box to the mounting flange portions of the mounting brackets using threaded fasteners;
step 203b involves positioning the electrical box at a desired position relative to a plane of the front wall; and
step 203c involves securing the electrical box at the desired position by tightening the threaded fasteners.

Whilst the invention has been described with reference to specific embodiments of the installation brackets, corresponding electrical box assemblies, and their methods of construction and use, such embodiments are merely intended to be illustrative of the invention and are in no way intended to be limiting. Other embodiments exist that have not been specifically described which nonetheless lie within the spirit and scope of the invention. It is the intention to include all such embodiments within the scope of the appended claims.

1. An installation bracket for mounting an electrical box to a partition comprising a front wall and a rear wall defining therebetween an interior space, the installation bracket comprising:
a mounting plate having an opening of sufficient size to receive therethrough an electrical device;
at least one stud or floor attachment means each for securing the installation bracket to at least one stud or floor, thereby to position the mounting plate alongside a rear face of the front wall in said interior space; and
at least one mounting flange on at least one side of said opening in said mounting plate, each mounting flange extending from said mounting plate toward said rear wall, for mounting thereupon an electrical box, each mounting flange defining at least two electrical box anchor positions located at different distances toward said rear wall from a plane of said mounting plate, said installation bracket thereby accommodating electrical boxes of varying depths within the interior space of the partition.

2. The installation bracket of claim 1, wherein each mounting flange defines at least two fastener apertures or at least one fastener slot for receiving at least one corresponding fastener therethrough for mounting an electrical box to each mounting flange, thereby to define said at least two anchor positions.

3. The installation bracket of claim 1, wherein said at least one mounting flange includes two opposing mounting flanges arranged on opposite sides of said opening in said mounting plate, and extending from said mounting plate toward said rear wall, for mounting therebetween an electrical box.

4. The installation bracket of claim 3, wherein the two opposing mounting flanges, or portions thereof, are moveable relative to one another to increase or decrease a distance therebetween, thereby to accommodate mounting of electrical boxes of varying widths or heights.

5. The installation bracket of claim 4, wherein the two opposing mounting flanges, or portions thereof, are slidably mounted to said mounting plate, such that they remain substantially perpendicular to a plane of the mounting plate and substantially parallel to one another, during relative movement thereof.

6. The installation bracket of claim 4, wherein the mounting plate comprises two distinct mounting plate sections, each integral with one of said opposing mounting flanges, said mounting plate sections being moveable relative to one another to vary a distance between the mounting flanges, such that the mounting flanges remain substantially perpendicular to said front wall, and substantially parallel to one another, during relative movement thereof.

7. The installation bracket of claim 6, wherein the mounting plate sections are slidably mounted to one another thereby to increase or decrease a distance between the mounting flanges.

8. The installation bracket of claim 1, wherein each of said at least two anchor positions are defined by at least one slot in each of said mounting flanges, each slot extending substantially perpendicularly to each mounting plate and adapted to receive therethrough a fastener for attachment to an electrical box.

9. The installation bracket of claim 8, wherein each mounting flange includes two slots running substantially parallel to one another, such that an electrical box may be slidably mounted by fasteners to the installation bracket, and selectively secured in a desired position relative to the mounting plate by tightening said fasteners in said slots.

10. The installation bracket of claim 1, wherein the mounting plate and each mounting flange are formed from a metallic sheet, each mounting flange being formed my bending a portion of the metallic sheet substantially perpendicular to a main plane of the sheet.

11. The installation bracket of claim 1, wherein the opening in the mounting plate is of sufficient size to receive therethrough said electrical box.

12. The installation bracket of claim 11, wherein the opening in the mounting plate is slightly larger than said electrical box, so that the electrical box is slidable through the opening to a desired depth in the interior space prior to securing of the electrical box to the installation bracket via the at least one mounting flange.

13. An electrical box assembly comprising:
(1) the installation bracket of any one of claims 1 to 12;
(2) an electrical box for mounting to the mounting flange(s) of the installation bracket; and
(3) a plurality of fasteners to fasten components (1) and (2) together.

14. The electrical box assembly of claim 13, wherein the electrical box comprises a back plate portion and an annular extender, thereby to define an interior space open on an open side of said electrical box opposite said back plate and adjacent said installation bracket.

15. The electrical box of claim 14, wherein said back plate is selectively removable from said side walls to permit access to said interior of the electrical box on a side opposite said open side.

16. A method of securing an electrical box within an interior space of a partition including a front wall and a rear wall to define said interior space, the method comprising the steps of:
mounting the installation bracket of claim 1 to a stud or floor; and
mounting the electrical box to the mounting flange(s) of the installation bracket.

17. The method of claim 16, wherein the step of mounting the electrical box comprises:
slidably mounting the electrical box to the mounting flange(s) using threaded fasteners;
positioning the electrical box at a desired position relative to a plane of the mounting plate; and
securing the electrical box at said desired position by tightening said threaded fasteners.

18. A kit for mounting an electrical box to a partition comprising a front wall and a rear wall defining therebetween an interior space, the kit comprising a first and second mounting bracket, each comprising:
a plate portion;
a stud or floor attachment means for securing the mounting bracket to a stud or a floor, thereby to position the plate portion of the mounting bracket alongside a rear face of the front wall in said interior space;
a mounting flange extending from said plate portion toward said rear wall, for mounting thereupon an electrical box, the mounting flange defining at least one electrical box anchor position;
whereby by in use said first and second mounting brackets are secured to a floor or stud so as to bring the mounting flanges into opposition, for securing therebetween an electrical box.

19. The kit of claim 18, wherein the mounting flanges in opposition define therebetween an opening of sufficient size to receive therethrough said electrical box, and optionally the opening is slightly larger than said electrical box, so that the electrical box is slidable through the opening to a desired depth in the interior space prior to securing of the electrical box to the mounting brackets via the at least one mounting flange.

20. The kit of claim 18, further comprising any one or more additional components selected from:
an electrical box;
a plurality of fasteners to fasten each mounting bracket to a stud or floor; and
a plurality of fasteners to fasten each mounting bracket to a box ring, or any electrical box, or to fasten the mounting brackets to one another.

21. The kit of claim 18, wherein each mounting flange of each mounting bracket comprises at least two electrical box anchor positions located at different distances toward said rear wall from a plane of said front wall, said mounting bracket thereby accommodating electrical boxes of varying depths within the interior space of the partition.

22. The kit of claim 21, wherein each of said at least two electrical box anchor positions are defined by at least one slot in each of said mounting flanges, each slot extending substantially perpendicular to each mounting plate and adapted to receive therethrough a fastener for attachment to an electrical box.

23. The kit of claim 18, wherein the first and second mounting brackets are connectable for sliding engagement therebetween, a distance between said opposed mounting flanges being adjustable by sliding said first mounting bracket relative to said second mounting bracket.

24. A method of securing an electrical box within an interior space of a partition including a front wall and a rear wall to define said interior space, the method comprising the steps of:
providing the kit of claim 18;
mounting each of said first and second mounting brackets to a stud or floor to bring the mounting flange portions of each mounting bracket into opposition; and
mounting the electrical box between the opposed mounting flange portions of the mounting brackets.

25. The method of claim 24, wherein the step of mounting the electrical box comprises:
slidably mounting the electrical box to the mounting flange portions of the mounting brackets using threaded fasteners;
positioning the electrical box at a desired position relative to a plane of the front wall; and
securing the electrical box at said desired position by tightening said threaded fasteners.
